(19) United States
(12) Patent Application Publication
(10) Pub. No.: US 2008/0243705 A1
(43) Pub. Date: Oct. 2, 2008

(54) Third-Party Gift Registry And Payment System

(75) Inventor: Scott Paintin, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 11/692,456

(22) Filed: Mar. 28, 2007

(51) Int. Cl. H04L 9/00

(52) U.S. Cl. 705/78

(57) ABSTRACT

A third-party gift registry system is disclosed. The system provides consumers access to at least one third-party gift registry. The at least one third-party gift registry includes a listing of gifts selected by a registrant at least one merchant. The system receives a gift selection from a consumer for a gift listed in a first third-party gift registry. A payment may then be received from the consumer at an agent location for the gift selection. The system then transfers at least a portion of the payment for the gift selection to the third-party merchant.

### BACKGROUND OF THE INVENTION

This disclosure relates in general to gift registry systems and by way of example, but not by way of limitation, to third-party gift registry and money transfer systems amongst other things.

Gift registries permit individuals expecting gifts at a significant event in their life to identify products of interest. Bridal registries, for example, permit an engaged couple to select items that they would like to receive as wedding gifts. The registry takes the guess work out of gift buying, permitting the gift buyer the satisfaction and peace of mind that the gift is something the recipient actually wants. Registries also track which gifts have been purchased and does not permit multiple gift givers to give the same gift. Gift registries are typically maintained by a store and limited to products within the store. Registrants who wish to receive gifts from different stores are required to register at multiple stores. There is a general need to provide enhancements to gift registries.

### BRIEF SUMMARY OF THE INVENTION

In one embodiment of the invention, a third-party gift registry system is disclosed. The third-party gift registry system includes a third-party merchant interface, a consumer interface and a money transfer interface. The third-party merchant interface is adapted to communicate with more than one third-party merchant. Each third-party merchant maintains a gift registry and each gift registry includes a listing of merchandise selected for entry within the gift registry by a registrant. The consumer interface is operable to provide access to at least one third-party merchant gift registry, operable to receive a gift selection selected from one of the third-party gift registries from the consumer, and operable to receive funds as payment for the gift selection from the consumer. The money transfer interface is adapted to communicate money transfer information between the third-party gift registry system and a money transfer system. The money transfer system may transfer the funds received as payment for the gift selection to the third-party merchant where the gift selection was selected.

The third-party gift registry may request through the third-party merchant interface that a third-party merchant remove the gift selection from the gift registry upon receiving payment for the gift selection. The money transfer interface may be adapted to communicate with an automated clearing house. The third-party gift registry system may send a message to the third-party merchant including, such as, a consumer name, a personal message from the consumer to the registrant to accompany the selected gift, quantity, purchase price, or gift identifier. The money transfer system may include an automated clearing house.

In another embodiment of the invention, a third-party gift registry system is disclosed. The third-party gift registry system may include a third-party merchant interface, a money transfer interface, a master gift registry, and a consumer interface. The third-party merchant interface may be adapted to communicate with more than one third-party merchant. The money transfer interface may be adapted to communicate money transfer information between the third-party gift registry and a money transfer system. The master gift registry may include more than one gift registry from more than one third-party merchant. The consumer interface may be adapted to communicate products within the master gift registry to a consumer. The master gift registry may include a plurality of products selected for the master gift registry by a registrant. The consumer interface may be adapted to receive from a consumer a gift selection of at least one product from the master gift registry. A product may be tangible personal property, intangible property or a service. The consumer interface may be adapted to receive payment details from the consumer for the selection of at least one product. The money transfer interface may be adapted to send a money transfer request to the money transfer system to transfer money to the third-party merchant.

The third-party gift registry system may remove a selected product from the master gift registry for the specific gift recipient when it has been purchased. The network interface may include the money transfer interface and the third-party interface. The third-party gift registry system may include a network interface comprising the money transfer interface, the consumer interface, and the third-party interface. The money transfer system may include an automated clearing house.

In another embodiment of the invention, a third-party gift registry method is disclosed. The third-party gift registry method may provide access to a consumer to more than one third-party gift registry, receive a gift selection from the consumer for a gift listed in a first third-party gift registry, receive a payment from the consumer for the gift selection and transfer at least a portion of the payment for the gift selection to the first third-party merchant. Each third-party gift registry may include a listing of gifts selected by a registrant and the more than one third-party gift registry comprises a first third-party gift registry. Sending a payment may include transferring money to the third-party merchant's financial account, sending a check to the third-party merchant; sending a negotiable instrument to the third-party merchant, transferring a credit to a stored value account, or through a net settlement at a financial institution. A message to the third-party merchant may be sent from the third-party gift registry including consumer name, a personal message from the consumer to the registrant to accompany the selected gift, quantity, purchase price, gift identifier, etc. Funds may be transferred through an automated clearing house. A portion of the payment for the gift selection may be retained as a fee for hosting the third-party gift registry. A consumer may also be charged a fee for sending a payment for the gift selection. A request to the first third-party merchant to remove the selected gift from the gift registry may be sent.

As another embodiment of the invention, a web based third-party gift registry method is disclosed. The method may include receiving a plurality of gift ideas from a registrant, entering the plurality of gift ideas in a master gift registry including the link to each gift idea at the third-party webpage, providing a listing of the gift ideas in the gift registry to a consumer, receiving a payment for the gift selection from the consumer, and transferring at least a portion of the payment to the third-party merchant. The plurality of gift ideas are found at a plurality of third-party merchants, and the plurality of gift ideas include a link to the gift idea at the third-party merchant webpage. Funds may be transferred with an automated clearing house. A gift idea is flagged as already purchased in the gift registry when the gift idea has been selected by a consumer and a payment has been received. Shipping information may be sent to the third-party merchant, with the registrant's shipping information.

### BRIEF DESCRIPTION OF THE DRAWINGS

The present disclosure is described in conjunction with the appended figures.

FIG. 1 shows a third-party gift registry system according to one embodiment of the invention.

FIG. 2 shows screenshots of an Internet based third-party gift registry system according to one embodiment of the invention.

FIG. 3 shows a flowchart for providing a third-party gift registry to a consumer according to one embodiment of the invention.

FIG. 4 shows a third-party gift registry system with a gift registry database according to another embodiment of the invention.

FIG. 5 shows screenshots of another Internet based third-party gift registry system according to one embodiment of the invention.

FIG. 6 shows a flowchart for providing a third-party gift registry to a consumer according to one embodiment of the invention.

FIG. 7 shows screenshots for registering for an Internet based third-party gift registry system according to one embodiment of the invention.

FIG. 8 shows a flowchart for providing a third-party gift registry system according to one embodiment of the invention.

In the appended figures, similar components and/or features may have the same reference label. Where the reference label is used in the specification, the description is applicable to any one of the similar components having the same reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

In one embodiment, the present disclosure provides for a third-party gift registry. The third-party gift registry provides gift buyers (or consumers) the option to find a gift at a single gift registry that contains gift ideas at one or more merchants. The third-party gift registry may also provide a convenient and simple money transfer mechanism to pay for a selected gift from the gift registry. In one embodiment, the third-party gift registry is maintained in a single location. In another embodiment, each retailer maintains a unique gift registry and the third-party gift registry system provides access and payment structure for the gift registry.

In another embodiment, an Internet-based third-party gift registry is disclosed. The web based third-party gift registry permits registrants to select gift ideas from other web-based retailers for inclusion in the gift registry. The third-party gift registry then provides a listing of gift ides selected by the registrant to gift buyers for selection. Once a gift idea has been selected, the third-party gift registry receives the funds and makes the proper payment to the merchant associated with the gift. The third-party gift registry may also request that the merchant deliver the gift to the recipient's address.

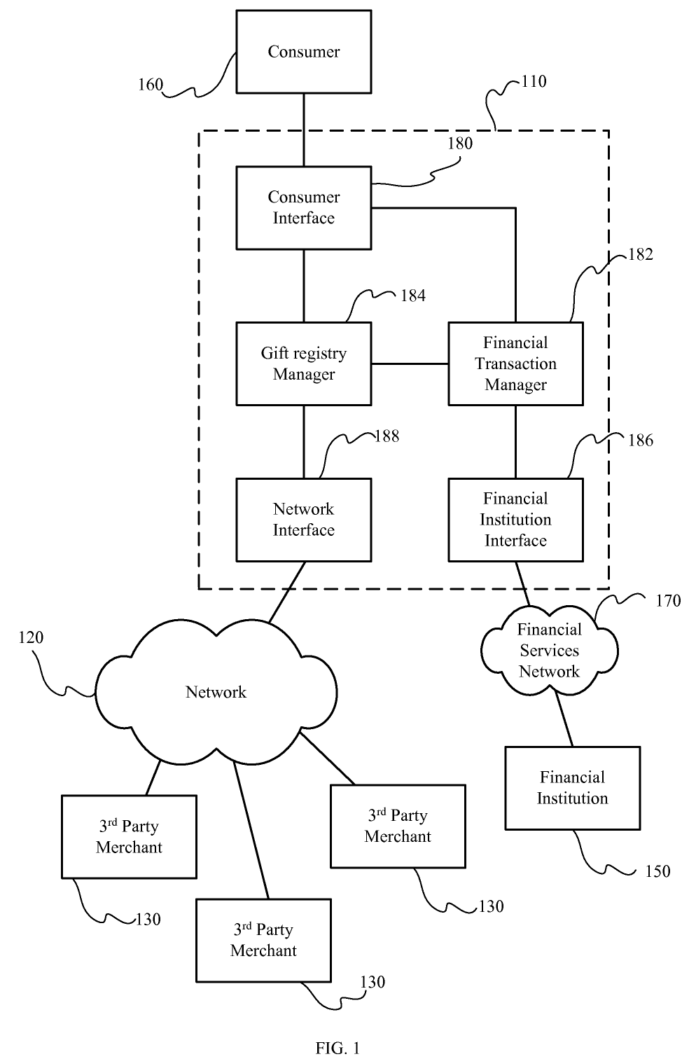

Referring first to FIG. 1, a money transfer and gift registry system 110 is coupled with a consumer 160, third-party merchants 130 through a network 120 and a financial services network 170 according to one embodiment of the invention. In some embodiments, the network 120 includes the financial services network 170. In other embodiments the financial services network 170 includes an ATM network, a debit network, a credit network, a stored value network, a money transfer network or the like. In another embodiment the financial services network 170 is any network coupled to an automated clearing house (ACH) that facilitates financial transactions at the ACH. The ACH network is a national electronic payments network used by financial institutions and corporations for settling accounts. ACH transfers are well known within the art and will not be described further. The network 120 may include the Internet, an intranet, a telephone network or the like.

The financial services network 170 is coupled with at least one financial institution 150. The financial institution 150 may include any financial institution adapted to complete or participate in a financial transaction. For example, the financial institution 150 may be an ACH. The financial institution 150 may also be a bank, credit union, credit card institution or association, debit card network or association, stored value card issuer, stored value account provider, a money transmitter, a money transfer agent, etc. More than one financial institution 150 may be coupled with the financial services network 170.

The money transfer and gift registry system 110 is also coupled with a consumer 160. The consumer 160 may have access to the money transfer and gift registry system 110 through a network, over the phone, over the Internet, or in person at a location. The consumer 160 may have access to the money transfer and gift registry system 110 over the network 120.

The money transfer and gift registry system 110 may also be coupled to one or more third-party merchants 130 through the network 120. The third-party merchant 130 may include any merchant that participates in a gift registry. The merchant's gift registry may be maintained at a third-party merchant 130. For example, the merchant may maintain the gift registry on a server and provide it to consumers through a webpage. The merchant may also offer the gift registry on a server hosted and/or maintained by a third-party. Each of the third-party merchants 130 may be associated with a financial institution 150. The third-party merchants may also have an account at a third-party merchant that is coupled to the money transfer and gift registry system 110 through the financial services network 170.

The money transfer and gift registry system 110 provides a gift registry to the consumer 160 with listings of gift ideas selected by the registrant at a third-party merchant 130. In one embodiment, the gift registrant may create the listing of gift ideas at each third-party merchant 130 and then the third-party merchant 130 provides the gift idea listing to the money transfer and gift registry system 110. In another embodiment, the listing of gift ideas may be created and maintained at the money transfer and gift registry system 110. In yet another embodiment, the listing of gift ideas at each third-party merchant 130 may be provided through the money transfer and gift registry system 110 and maintained at or for the third-party merchant 130.

The money transfer and gift registry system 110 may also provide a centralized payment system for purchasing a gift through the money transfer and gift registry system 110. When a consumer 160 selects a gift from the gift registry, the money transfer and gift registry system 110 may accept payment for the gift. The money transfer and gift registry system 110 may then transfer payment to a third-party merchant 130. The money transfer and gift registry system 110 may also retain a fee for providing the gift registry to the consumer 160. The fee may be charged to the consumer 160 and/or the third-party merchant 130. The money transfer and gift registry system 110 may initiate a money transfer through the financial services network 170 and the associated financial institution 150. For example, the money transfer and gift registry system 110 may institute a payment through an ACH coupled to the financial services network 170. Payment of funds may be transferred from an account held by the consumer 160 at a financial institution 150 to the third-party merchant 130 or a financial institution 150 maintaining an account for the third-party merchant 130. In another embodiment, the money transfer and gift registry system 110 may receive funds from the consumer 160 to purchase a gift for the recipient and may transfer the funds from the money transfer and gift registry system 110 or a financial institution 150 to the third-party merchant 130 or a financial institution 150 maintaining an account for the third-party merchant 130.

The money transfer and gift registry system 110 may also include a consumer interface 180. The consumer interface 180 is adapted to communicate with a consumer 160. The consumer interface 180 may provide access for consumers to the third-party gift registries through the money transfer and gift registry system 110 through a network, over the phone, or in person at a retail location. The consumer interface 180 may also provide access to the money transfer and gift registry system 110 over a network 120 by providing a web page providing access to third-party gift registries 130. The consumer interface 180 may also receive payments for selected gifts. For example, the consumer interface 180 may include a credit card reader, a debit card PIN entry device, a point of sale device, cash machine, or use a teller to receive funds from the consumer. Moreover, payments may be received over the Internet from a credit card, debit card, ATM card, money transfer, stored value card, prepaid card, stored value account, etc.

The consumer interface 180 may communicate with a gift registry manager 184. The gift registry manager 184 manages the gift registries maintained at the third-party merchants. The gift registry manager 184 may also be coupled with a network interface 188 as well as a financial transaction manager 182.

The financial transaction manager 182 manages financial transactions. The financial transaction manager 182 may communicate with a financial institution or institutions 150 through a financial institution interface 186. The financial institution interface 186 may be coupled directly to a financial institution 150, the network 120, the Internet, a financial services network 170, an ATM network or the like. The financial transaction manager 182 receives payment information from the consumer interface 180. The financial transaction manager 182 may communicate with the gift registry manager 184. The financial transaction manager 182 may also communicate to the gift registry manager 184 that funds have been received for a specific transaction. Furthermore, the financial transaction manager 182 may request and receive financial payment information from the gift registry manager 184, such as, for example, the name of the third-party merchant 130, account number for the third-party merchant 130, amount to transfer to the third-party merchant 130, name of the financial institution, routing numbers, etc. The financial transaction manager 182 may also ensure that the proper third-party merchant 130 receives the proper payment for a gift purchased from the master gift registry 260.

The gift registry manager 184 may also be coupled with a third-party merchant interface 188. The network interface 188 may communicate with third-party merchants 130. The network interface 188 may be coupled to third-party merchants 130 over a network 120, such as the Intranet, a telephone network, an intranet, etc. The network interface 188 may also provide access for a consumer 160 to a gift registry maintained at or for a third-party merchant. The network interface 188 may also receive requests for payment from a third-party merchant 130 when a consumer 160 selects a gift from the gift registry.

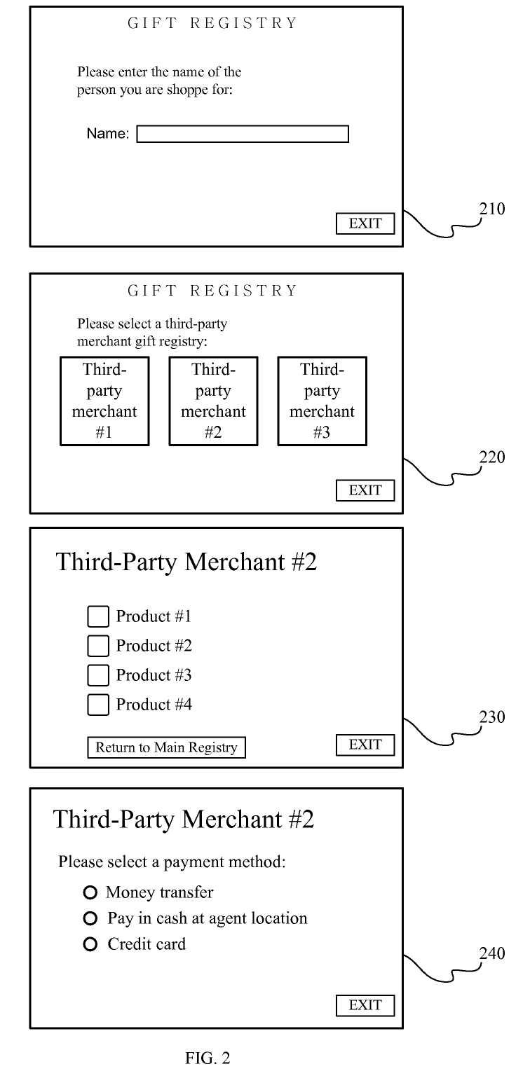

FIG. 2 shows an example of screenshots of a webpage implementation of the embodiment described in FIG. 1 according to one embodiment of the invention. A consumer 130 accesses the money transfer and gift registry system 110. The consumer 130 is presented with a webpage asking for information regarding the registrant for whom they wish to purchase a gift 210. As shown in the figure, the name of the person is requested. Other information may also be requested, such as, event type, event date, id number, user id, etc. Once the proper information is entered, the money transfer and gift registry system 110 may determine which third-party merchant gift registries the registrant has registered for. As shown in this example, the specified registrant has registered gift registries at three merchants, for example Sears®, Target®, and Macy's® at screenshot 220. The consumer 130 is then asked to select a merchant hosting a gift registry at screenshot 220. Once the consumer selects a merchant, the consumer is presented with a list of gift ideas within the merchant's gift registry for the specified registrant as shown at screenshot 230. In this example, the consumer chooses to select a gift from a merchant and is presented with a listing of gift ideas at the selected merchant. The listing of gifts may include a photograph of the gift, a description, a price, etc. The consumer may, at anytime return to the listing of participating merchants and select another merchant or exit the system. Once the consumer selects a gift, they are presented with payment options as shown at screenshot 240. The consumer may choose to pay for the gift, for example, using a money transfer, cash at an agent location, or using a credit card, a debit card, a prepaid card, an ATM card, a stored value card, a stored value account, check, money order or the like. To pay by cash, the consumer is provided a unique identifier that may be used at an agent location to pay for the gift with cash. The consumer may also pay with any other type of payment method at the agent location. The consumer may also pay at any other location, via the Internet (such as a through a webpage or electronic bill presentment and payment), over a telephone, at a kiosk or ATM, or through a mobile device. The unique identifier may expire after a specified period of time.

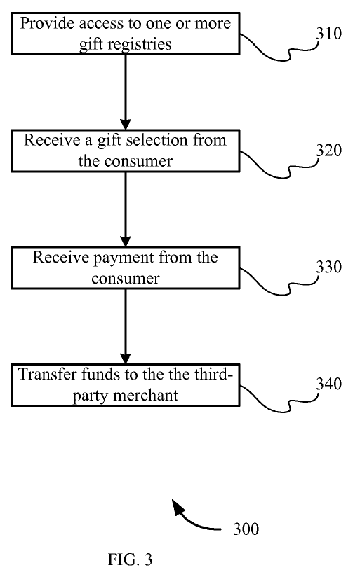

FIG. 3 shows a method 300 for providing a third-party gift registry at a money transfer and gift registry system 110 according to one embodiment of the invention. The money transfer and gift registry system 110 provides a consumer access to at least one gift registry at block 310. The gift registries may be provided over the Internet (an example of which is shown in FIG. 2), through the mail, by fax, as part of an invitation, over a telephone, over a mobile device, through a kiosk, through an ATM or at an agent location. The kiosk, for example, may be at a shopping mall and provide a listing of gift ideas for merchants located throughout the mall. The invitation, for example, may provide a listing of gift ideas that may be purchased over the phone or through the Internet. Those skilled in the art will recognize other ways to provide a gift registry to a consumer.

The consumer makes a gift selection, the gift selection is sent to the money transfer and gift registry system 110, and the gift selection is received by the money transfer and gift registry system 110 at block 320. The consumer's selection may be received through the consumer interface 180. Payment for the gift selection is received at block 330. Payment may also be received through the consumer interface 180. The payment may also include instructions and/or information to transfer funds for payment of the selected gift.

The proper funds are then transferred to the third-party merchant 130 that provided the selected gift at block 340. The money transfer is initiated and managed by the financial transaction manager 182 and sent through the financial transaction interface 186. Payment may also be received by the third-party merchant 130 through a money transfer to a bank account, through a check printer at the third-party merchant 130's location, through a negotiable instrument sent through the mail, through a credit in an account, through a credit to a stored value account, through a net settlement in an agent account (such as a WESTERN UNION® account), or through an agent at an agent location.

The following applications discuss various payment solutions and are incorporated by reference herein in their entirety for all purposes: U.S. patent application Ser. No. 10/444,928, entitled “CASH PAYMENT FOR REMOTE TRANSACTIONS,” filed May 22, 2003; U.S. patent application Ser. No. 10/289,802, entitled “METHOD AND SYSTEM FOR PERFORMING MONEY TRANSFER TRANSACTIONS,” filed Nov. 7, 2002; U.S. patent application Ser. No. 09/427,249, now U.S. Pat. No. 6,488,203, entitled “METHOD AND SYSTEM FOR PERFORMING MONEY TRANSFER TRANSACTIONS,” filed Oct. 26, 1999; U.S. patent application Ser. No. 10/401,506, entitled “ONLINE STAGING OF AUCTION SETTLEMENT TRANSACTIONS,” filed Mar. 27, 2003; U.S. patent application Ser. No. 10/262,529, entitled “WORLDWIDE CASH VENDOR PAYMENT,” filed Sep. 30, 2002; U.S. patent application Ser. No. 10/109,559, entitled “INTERNATIONAL NEGOTIABLE INSTRUMENT PAYMENT,” filed Mar. 27, 2002; U.S. patent application Ser. No. 10/045,313, entitled “INTERNET-BASED MONETARY PAYMENT SYSTEM,” filed Oct. 24, 2001; and U.S. patent application Ser. No. 09/307,485, entitled “INTERNET-BASED MONETARY PAYMENT SYSTEM,” filed May 10, 1999.

In another embodiment of the invention, when funds are received and transferred to a third-party merchant, an identifier and/or message may also be sent to the third-party merchant indicating which of the gift ideas in the gift registry was selected and paid for. In another embodiment of the invention, payment for selected gifts may be accomplished by transferring bulk payment for multiple selections by one or more consumers. The identifier may be sent to the third-party merchant 130 through the third-party merchant interface 188. In addition, when funds are received and transferred to a third-party merchant, a consumer-provided personal message may be included for the third-party merchant to deliver to the registrant with the selected gift.

The identifier may also include shipping information. Shipping information for the registrant may be saved in conjunction with the master gift registry. The shipping information may be sent to the third-party merchant 130 through the third-party merchant interface 188.

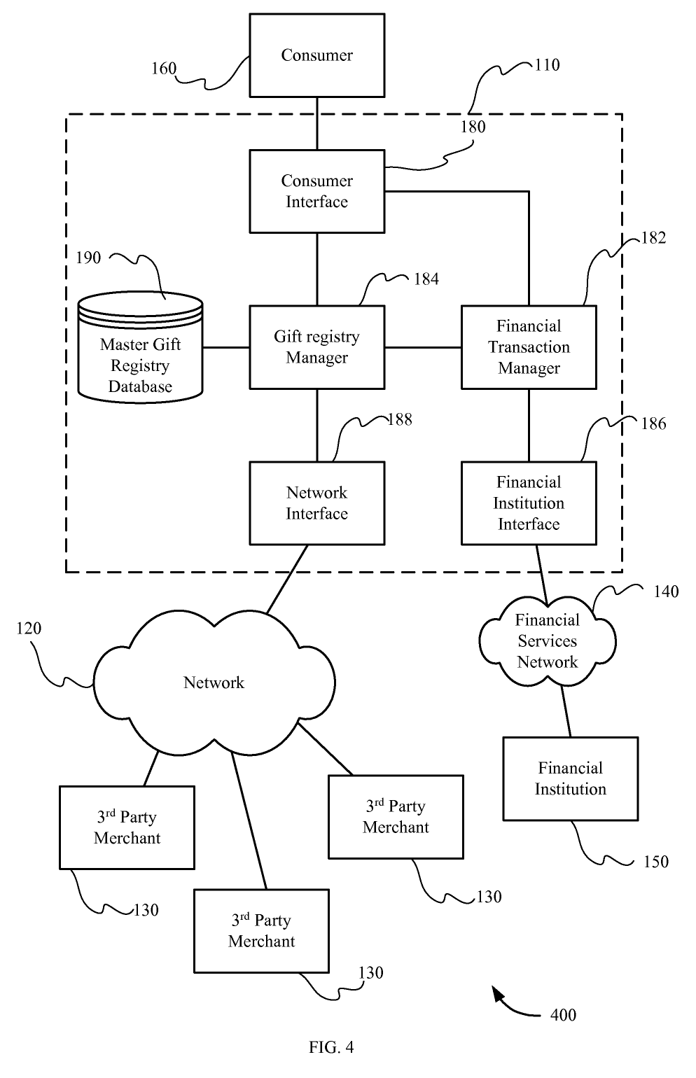

FIG. 4 shows a money transfer and gift registry system 110 incorporating a master gift registry database 190 according to one embodiment of the invention. The master gift registry database 190 includes gift registries from one or more third-party merchants 130 and is maintained at the money transfer and gift registry system 110. While the money transfer and gift registry system 110 is coupled with the network 110 as shown in the figure, it is not required. That is, the money transfer and gift registry system 110 may not be coupled to the network 120 and may not include a network interface 188. In such a case, the master gift registry database 190 may be populated with gift items from third-party merchants 130 that are entered manually at the money transfer and gift registry system 110. In embodiments employing a network interface 188 coupled with a network 120 the gift ideas may be entered and/or updated by a third-party merchant through the network 120.

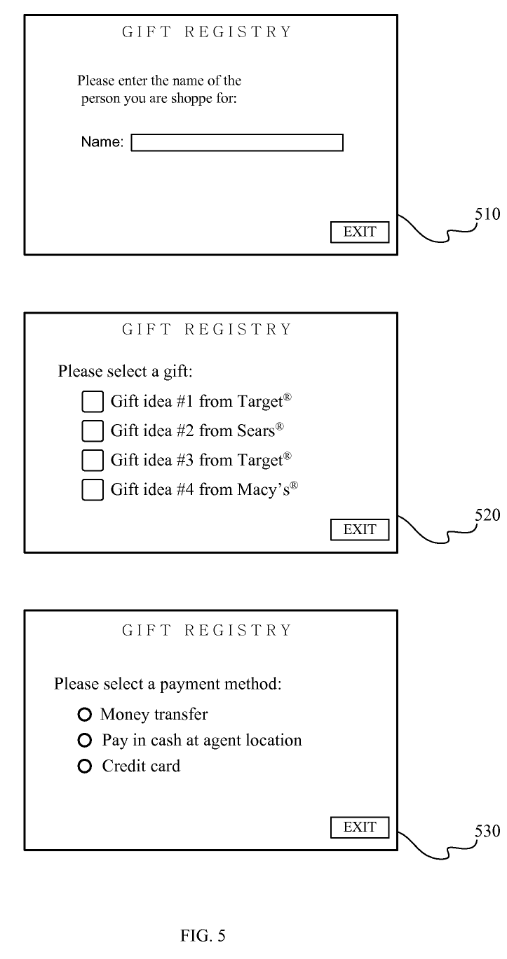

FIG. 5 shows an example of screenshots of a webpage implementation of the embodiment described in FIG. 4 according to one embodiment of the invention. A consumer 130 accesses the money transfer and gift registry system 110. The consumer 130 is presented with a webpage asking for information regarding the registrant for whom they wish to purchase a gift 510. As shown in the figure, the name of the person is requested. Other information may also be requested, such as, event type, event date, id number, user id, etc. Once the proper information is entered, the money transfer and gift registry system 110 may determine which of third-party merchant 130 gift registries the registrant has registered for. Once the registrant has been identified, the consumer is presented with a list of gift ideas found in the master gift registry for the specified registrant at screenshot 520. This listing of gift ideas may include the gift name, the merchant name from which the gift is being offered, a photograph of the gift, a description, a price, etc. The consumer may then choose a gift from the listing of gifts. Once the consumer selects a gift, they are presented with payment options as shown at screenshot 530. The consumer may choose to pay for the gift, for example, using a money transfer, providing cash at an agent location, or using a credit card, a debit card, a prepaid card, an ATM card, a stored value card, a stored value account, check, money order or the like. To pay by cash, the consumer is provided a unique identifier that may be used at an agent location to pay for the gift with cash. The consumer may also pay with any other type of payment method at the agent location. The consumer may also pay at any other location, via the Internet (such as a through a webpage or electronic bill presentment and payment), over a telephone, at a kiosk or ATM, or through a mobile device. The unique identifier may expire after a specified period of time.

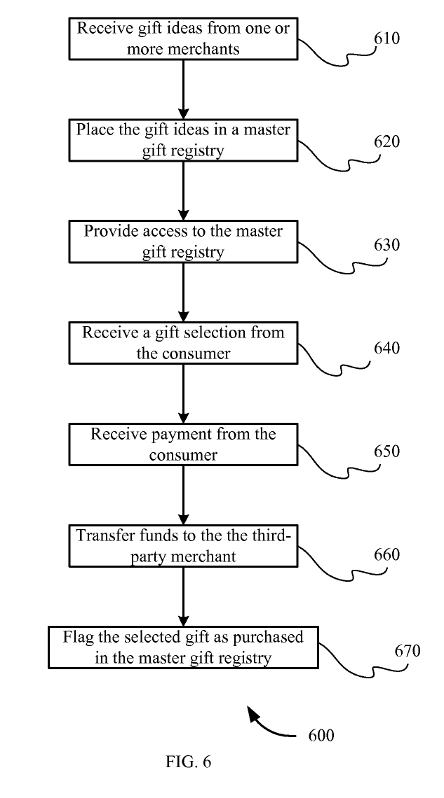

FIG. 6 shows another method 600 for providing a third-party gift registry at a money transfer and gift registry system 110 according to one embodiment of the invention. Gift ideas are received from a registrant at block 810. The gift ideas are grouped into a listing of items for sale at a third-party merchant 130 into a master gift registry. The gift ideas may be collected through the Internet, over the telephone, in person, at a kiosk, through handheld scanner, etc.

Once the gift ideas have been received from the registrant at block 610, the items are entered into the master gift registry at block 620 and then provided to a consumer at block 630. A consumer may gain access to the master gift registry through the Internet, over the phone, by receiving a catalog, at an agent location, at a kiosk, etc. The consumer is then free to make a gift selection from a listing of gift ideas provided from the master gift registry at block 640. A payment may also be received at block 650. The payment may include payment in the form of cash, a negotiable instrument, a credit card, a debit card, an ATM card, a stored value card, a stored value account, prepaid card, a money transfer from an account at a financial institution, a prepaid card, a stored value account, money order, etc. Payment may then be transferred to the third-party merchant 130 at block 660 and the gift is flagged as purchased within the master gift registry at block 670.

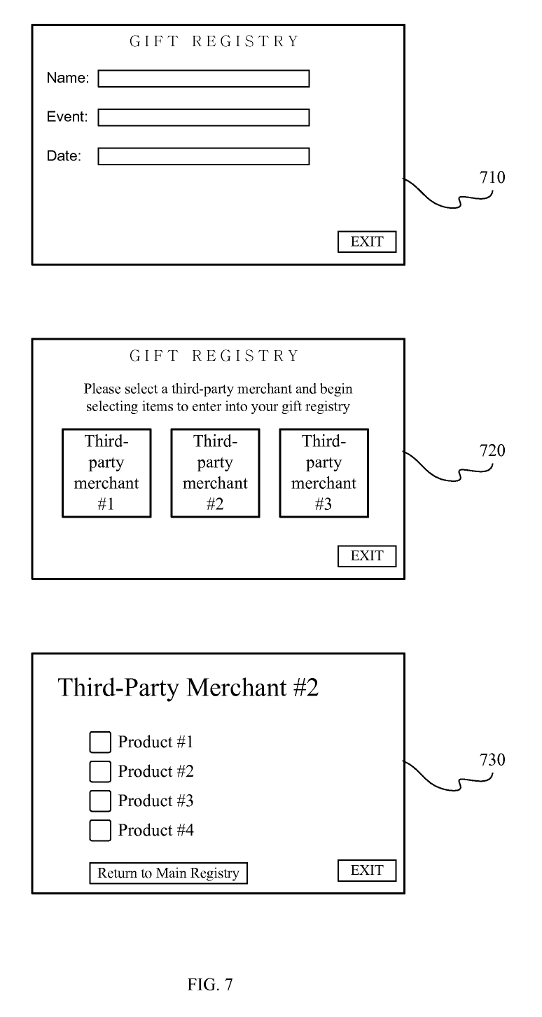

FIG. 7 shows screenshots for registering for an Internet based third-party gift registry system according to one embodiment of the invention. A registrant may register for a third-party gift registry system at a webpage, such as the webpage shown in screenshot 710. The webpage may ask for identifying information such as, for example, the registrant's name, the registrant's address and phone number, the names of others involved with the event (such as a fiancee), the type of event, the date of the event, etc. A registrant may also register in person, over the telephone or at a kiosk. Once the identifying information has been received, a gift registry may be created for the registrant. The registrant is presented with a listing of participating merchants at screenshot 720. Whereupon, by selecting a merchant, the registrant may be referred to the third-party merchant's webpage or other registry mechanism and may be provided with a listing of products as shown in screenshot 730. The registrant may select any of the listing of products for entry into the master gift registry database maintained at the money transfer and gift registry system 110.

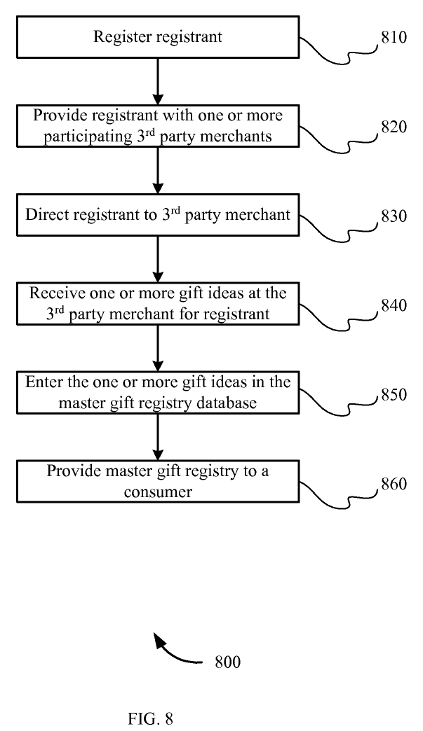

FIG. 8 shows a flowchart outlining a method 800 for registering for a third-party gift registry at a money transfer and gift registry system 110 according to one embodiment of the invention. A registrant accesses the money transfer and gift registry system 110 over the Internet, the phone, at a kiosk or in person and is registered for a gift registry at block 810. The registrant is provided with a list of third-party merchants participating in the gift registry at block 820. The registrant selects a merchant and is directed to the merchant for selection of gift ideas at block 830. The registrant may be directed to the third-party merchant's webpage, catalogue or store. The money transfer and gift registry system 110 then receives gift ideas selected by the registrant at the third-party merchant at block 840. The gift ideas may be sent by the registrant or the merchant to the system. The gift ideas are then placed in the master gift registry database held at the money transfer and gift registry system 110 at block 850. These gift ideas within the master gift registry database may then be provided to a consumer for purchase at block 860.

As used throughout this application, the terms merchant and/or retailer refer to a party providing items for sale and potentially participating with a group registry. The terms gift buyer and/or consumer refer to a individual or group that is buying a gift from the gift registry. The terms recipient, registrant, and gift registrant refer to an individual making and establishing a gift registry.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

1. A third-party gift registry system comprising:
a third-party merchant interface adapted to communicate with more than one third-party merchant, wherein each third-party merchant maintains a gift registry, and each gift registry comprises a listing of merchandise selected for entry within the gift registry by a registrant;
a consumer interface, wherein the consumer interface is operable to provide access to at least one third-party merchant gift registry, the consumer interface is operable to receive a gift selection from the consumer selected from one of the third-party gift registries, and the consumer interface is operable to receive funds as payment for the gift selection from the consumer; and
a money transfer interface adapted to communicate money transfer information between the third-party gift registry system and a money transfer system, wherein the money transfer interface transfers the funds received as payment for the gift selection to the third-party merchant where the gift selection was selected.

2. The third-party gift registry system of claim 1, wherein the third-party gift registry system requests through the third-party merchant interface that a third-party merchant remove the gift selection from the gift registry upon receiving payment for the gift selection.

3. The third-party gift registry system of claim 1, wherein the third-party gift registry system requests through the third-party merchant interface that a third-party merchant flag the gift selection in the gift registry upon receiving payment for the gift selection.

4. The third-party gift registry system of claim 1, wherein the money transfer interface is adapted to communicate with an automated clearing house.

5. The third-party gift registry system of claim 1, wherein the third-party gift registry systems sends a message to the third-party merchant, wherein the message comprises information selected from the group consisting of: consumer name, a personal message from the consumer to the registrant to accompany the selected gift, quantity, purchase price, and gift identifier.

6. The third-party gift registry system of claim 1, wherein the money transfer system comprises an automated clearing house.

7. A third-party gift registry system comprising:
a third-party merchant interface adapted to communicate with more than one third-party merchant;
a money transfer interface adapted to communicate money transfer information between the third-party gift registry and a money transfer system;
a master gift registry comprising more than one gift registry from more than one third-party merchant, wherein the master gift registry comprises a plurality of products selected for the master gift registry by a registrant; and
a consumer interface adapted to communicate products within the master gift registry to a consumer,
wherein:
the consumer interface is adapted to receive from a consumer a gift selection of at least one product from the master gift registry;
the consumer interface is adapted to receive payment details from the consumer for the selection of at least one product; and
the money transfer interface is adapted to send a money transfer request to the money transfer system to transfer money to the third-party merchant.

8. The third-party gift registry system of claim 7, wherein once the product has been paid for, the selected product is removed from the master gift registry for the specific gift recipient.

9. The third-party gift registry system of claim 7, wherein once the product has been paid for, the selected product is flagged in the master gift registry for the specific gift recipient.

10. The third-party gift registry system of claim 7, further comprising a network interface comprising the money transfer interface and the third-party interface.

11. The third-party gift registry system of claim 7, further comprising a network interface comprising the money transfer interface, the consumer interface, and the third-party interface.

12. The third-party gift registry system of claim 7, wherein the money transfer system comprises an automated clearing house.

13. A third-party gift registry method comprising:
providing access to at least one third-party gift registry, wherein the at least one third-party gift registry includes a listing of gifts selected by a registrant at least one merchant, and the at least one third-party gift registry comprises a first third-party gift registry;
receiving a gift selection from a consumer for a gift listed in the first third-party gift registry;
receiving a payment from the consumer through a financial services facilitator for the gift selection; and
transferring at least a portion of the payment for the gift selection to the first third-party merchant.

14. The third-party gift registry method of claim 13, wherein:
the providing access to at least one third-party gift registry comprises providing access to at least one third-party gift registry over the Internet; and
the receiving a gift selection from a consumer for a gift listed in the first third-party gift registry comprises receiving a gift selection from a consumer for a gift listed in the first third-party gift registry over the Internet.

15. The third-party gift registry method of claim 13, further comprising flagging the gift selection as selected by a consumer pending payment at the agent location.

16. The third-party gift registry method of claim 15, further comprising removing the flag after a period of time if a payment is not received at an agent location.

17. The third-party gift registry method of claim 13, wherein the sending at least a portion of the payment for the gift selection comprises a payment method selected from the group consisting of: transferring money to the third-party merchant's financial account, sending a check to the third-party merchant; sending a negotiable instrument to the third-party merchant, transferring a credit to a stored value account, providing a payout card, providing cash at an agent location, and through a net settlement at a financial institution.

18. The third-party gift registry method of claim 13, further comprising sending a message to the third-party merchant, wherein the message includes information selected from the group consisting of: consumer name, a personal message from the consumer to the registrant to accompany the selected gift, quantity, purchase price, and gift identifier.

19. The third-party gift registry method of claim 13, wherein the transferring at least a portion of the payment for the gift selection to the first third-party merchant comprises transferring funds through an automated clearing house.

20. The third-party gift registry method of claim 13, further comprising retaining a portion of the payment for the gift selection.

21. The third-party gift registry method of claim 13, further comprising sending a request to the first third-party merchant to remove the selected gift from the gift registry.

22. The third-party gift registry method of claim 13, further comprising sending a request to the first third-party merchant to flag the selected gift in the gift registry.

23. A web based third-party gift registry method comprising:
receiving a plurality of gift ideas from a registrant, wherein the plurality of gift ideas are found at a plurality of third-party merchants, and the plurality of gift ideas include a link to the gift idea at the third-party merchant webpage;
entering the plurality of gift ideas in a master gift registry including the link to each gift idea at the third-party webpage;
providing a listing of the gift ideas in the gift registry to a consumer;
receiving a gift selection from the consumer;
receiving a payment for the gift selection from the consumer; and
transferring at least a portion of the payment to the third-party merchant.

24. The web-based third-party gift registry method of claim 23, wherein the transferring at least a portion of the payment to the third-party includes transferring funds with an automated clearing house.

25. The web-based third-party gift registry method of claim 23, further comprising flagging a gift idea as already purchased in the gift registry when the gift idea has been selected by a consumer and a payment has been received.

26. The web-based third-party gift registry method of claim 23, further comprising sending shipping information to the third-party merchant, wherein the shipping information comprises the registrant's shipping information.

27. The third-party gift registry method of claim 13, wherein the financial services facilitator comprises a facilitator selected from the group consisting of an agent location, an ATM, a kiosk location, the Internet; a mobile device, a telephone, and a mobile phone.
